(19) United States
(12) Patent Application Publication
(10) Pub. No.: US 2024/0411746 A1
(43) Pub. Date: Dec. 12, 2024

(54) DATA ENRICHMENT USING GENERATIVE SERVICES FOR DATABASE SYSTEMS

(71) Applicant: Salesforce, Inc., San Francisco, CA (US)

(72) Inventor: Gang Shu, San Francisco, CA (US)

(73) Assignee: Salesforce, Inc., San Francisco, CA (US)

(21) Appl. No.: 18/330,985

(22) Filed: Jun. 7, 2023

(51) Int. Cl. G06F 16/23; G06F 16/215; G06F 40/186

(52) U.S. Cl. CPC G06F 16/2365; G06F 16/215; G06F 40/186

(57) ABSTRACT

In some embodiments, a method selects a set of fields for a record in a database system. A set of prompt templates is retrieved that is associated with the set of fields. A prompt template comprises text and a variable. The method searches information that is associated with the record to determine context information and inserts the context information into the prompt templates to generate a set of prompts. The set of prompts is input into a generative model to output a generated result. The generative model is trained to output text based on prompts. The method outputs enrichment data for the record on an interface, wherein the enrichment data is based on the text of the generated result.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever

### FIELD OF TECHNOLOGY

This patent document relates generally to databases and more specifically to using generative services to automatically enrich database data.

### BACKGROUND

A management system, such as a Customer Relationship Management (CRM) system, requires complete and accurate data. The management system is designed to help companies manage their interactions with customers and leads, track sales, and identify opportunities for growth. To achieve these goals, the management system requires reliable and relevant data. Incomplete or inaccurate data may negatively impact the effectiveness of the system, which may lead to poor decision making by users of the system. For example, if a customer's contact information is missing or outdated, it may result in failed outreach attempts or missed sales opportunities. Additionally, inaccurate data can cause a loss of credibility and trust between companies and customers, which may result in damage to the company's reputation.

A traditional way of entering data in the management system requires a lot of manual effort, which is time consuming and prone to human error. For example, a user, such as a sales representative or a service agent, may collect information during interactions with customers, and manually type in information in the appropriate fields in the system. Also, sales representatives and service agents may perform research to learn more about a customer's company, industry, and/or background. This may involve searching for information on the customer's website, social media profiles, news articles, other online sources. The manual actions above may use a large number of human resources and take a lot of time. Also, some information may be inaccurate.

### BRIEF DESCRIPTION OF THE DRAWINGS

The included drawings are for illustrative purposes and serve only to provide examples of possible structures and operations for the disclosed inventive systems, apparatus, methods and computer program products for data enrichment system. These drawings in no way limit any changes in form and detail that may be made by one skilled in the art without departing from the spirit and scope of the disclosed implementations.

FIG. 1 depicts a simplified system for generating enrichment data according to some embodiments.

FIG. 2 depicts a more detailed example of generative data enrichment system according to some embodiments.

FIG. 3 depicts a more detailed example of a prompt provider according to some embodiments.

FIG. 4 depicts a more detailed example of a context provider according to some embodiments.

FIG. 5 is simplified flow chart for generating enrichment data according to some embodiments.

FIG. 6 depicts a simplified flow chart of a method for enriching a record with data generated by a generative model system according to some embodiments.

FIG. 7A depicts an example of a portion of a page with fields and enrichment data according to some embodiments.

FIG. 7B depicts an example of enriching a picklist field according to some embodiments.

FIG. 8 depicts an example of a page for a record according to some embodiments.

FIG. 9 depicts an example of a user interface for a case record according to some embodiments.

FIG. 10 shows a block diagram of an example of an environment that includes an on-demand database service configured in accordance with some implementations.

FIG. 11A shows a system diagram of an example of architectural components of an on-demand database service environment, configured in accordance with some implementations.

FIG. 11B shows a system diagram further illustrating an example of architectural components of an on-demand database service environment, in accordance with some implementations.

FIG. 12 illustrates one example of a computing device.

### DETAILED DESCRIPTION

### System Overview

A system may enrich data in a database system, such as a customer relationship management (CRM) system or other management systems. The generative data enrichment system may generate enrichment data, and provide the enrichment data for input into the system. In some embodiments, the generative data enrichment system may be used to generate enrichment data for records in the management system. For example, the generative data enrichment system may provide insights into customer behavior and preferences, and information for fields, by analyzing large volumes of data and identifying patterns and trends that might not be immediately apparent to human analysts.

In some examples, a user may maintain records in the management system, such as records that summarize information, such as customers or potential customers. In a sales scenario, the generative data enrichment system may generate insights into leads, accounts, contacts, etc. For example, insights into the company portfolio, industry trends, competitors, public financial reports, and so on, may be generated. In service scenarios, the generative data enrichment system may generate insights into cases, work orders, etc. For example, the generative data enrichment system may generate an executive summary of interactions with customers, customer sentiment, suggested next step actions, etc.

The generative data enrichment system may automate the process of data entry, which reduces the time and effort required to enter data manually. For example, the generative data enrichment system may extract data from customer conversations, and populate data into a field for a user, such as a sales representative or a service agent, to review and approve. This can significantly improve the accuracy and completeness of data, eliminate errors, and minimize the risk of missing critical information. Accordingly, the generative data enrichment system may help businesses leverage their customer data to make informed decisions, improve customer relationships, and drive business growth.

The generative data enrichment system may use a process that can analyze a record to generate fields for a type of entity for the record. The type of entity may be based on characteristics of the record, such as whether the record is a lead, case, etc. The generative data enrichment system may use the fields to generate prompt templates. Also, the generative data enrichment system may generate a context for the record. The context may be a company name, an industry, or other related information from the record. The context and the prompt templates are used to generate prompts for a model, which generates a result from the prompts. For example, a generative model, such as a large language model, may be used to generate results, which may be human readable text. The generated results may be used to determine enrichment data for the record, which may then be provided to a user, such as displayed on a user interface for the record. The user can then review the enrichment data, edit the enrichment data, or accept the enrichment data.

The enrichment data may be generated in an improved process. For example, the prompts that are used in a generative model affect the quality of the results. The prompts are generated in an improved process using the prompt templates and context. This provides more robust enrichment data for records.

In some examples, a user of a CRM system may have a customer. The user inputs data about the customer interactions in a record. Typically, the user can access the record and only see the information that has been manually input. However, using the generative data enrichment system, information associated with the record may be used to generate prompts. Those prompts are input into the generative model, which outputs a result that is used to determine enrichment data. The CRM system may then output the enrichment data for the record. For example, the CRM system may provide enrichment data to fill in fields of the record. Also, the CRM system may provide additional insights for the customer. Other information may also be provided with the enrichment data. As a result, the record for the customer is more robust using the enrichment data and the user can improve his/her relationship with the customer using the improved record. Accordingly, the database system is improved by enriching stored data for a record. Also, the user interface is improved by providing insights that may not be possible for a human to determine.

### System

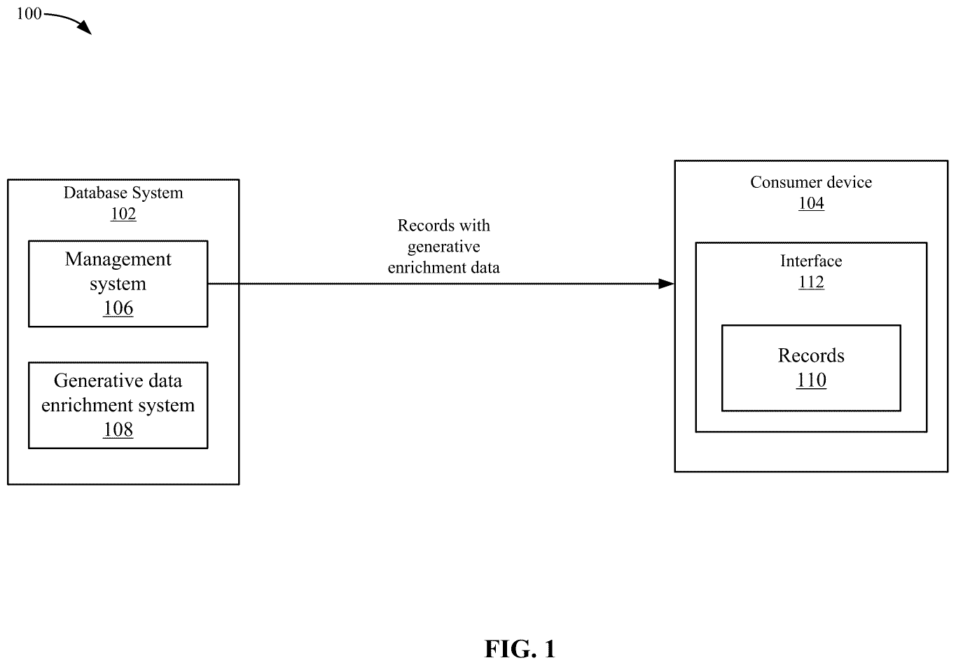

FIG. 1 depicts a simplified system 100 for generating enrichment data according to some embodiments. System 100 includes a database system 102 and a consumer device 104. Although a single instance of database system 102 and consumer device 104 are shown, multiple instances of either may be provided. For example, multiple consumer devices 104 may be using database system 102. In some embodiments, database system 102 may be implemented in a multi-tenant database system, which is described in more detail below.

Database system 102 includes a management system, such as CRM system 106, that may manage data, such as for customers of a company. Although a CRM system is described, other systems may use the generative data enrichment system as described below.

Consumer device 104 may access records of management system 106, which are displayed on an interface 112. At 110, records may display information about an entity, such as a customer, a product, etc. For example, the records may include fields that display information, such as contact names, company names, and other data.

A generative data enrichment system 108 analyzes information associated with records and generates enrichment data. Generative data enrichment system 108 may use a model that outputs generated results. In some embodiments, the model may be a generative model, such as a large language model, that may include a neural network with parameters that are trained on large quantities of text. The output of the generative model may be human readable text that is generated based on the prompts that are provided. The text may be human-readable and is coherent and grammatically accurate. Although a large language model is described, other models that can generate human readable text may be appreciated.

The quality of the prompts is important to generate relevant, useful, and accurate results. Using poorly generated prompts may cause the results that are output by the model to be not useful or inaccurate. Generative data enrichment system 108 may generate relevant and useful prompts for input into the model. The prompts may be generated in an improved manner by using fields that are selected based on metadata for the record. The metadata may indicate a type of record, which is used to generate prompt templates. Also, a context may be generated from information that is associated with the record and used to substitute information in the prompt templates to generate the prompts for input into the generative model. This may improve the prompts that are used, which improves the generated results that are output by the generative model.

### Generative Data Enrichment System

In some examples, a sales representative, Jane, meets a prospective customer, Bill, at a trade fair and captures Bill's basic information like name, company, and title. Two days later, Jane browses Bill's lead record. Jane uses the information to create a potential lead that can lead to business. At this time, the record page for the lead is opened, and the data enrichment process may be initiated. The following describes the process.

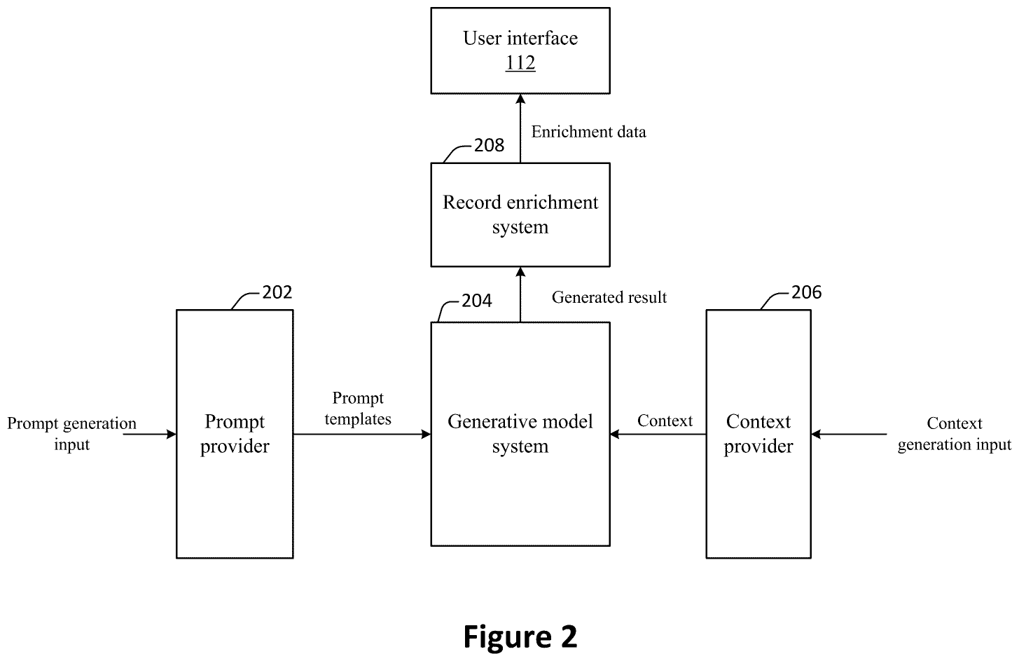

FIG. 2 depicts a more detailed example of generative data enrichment system 108 according to some embodiments. Generative data enrichment system 108 may include a prompt provider 202, a generative model system 204, a context provider 206, and a record enrichment system 208. Additional details of entities in generative data enrichment system 108 will be described more detailed in the following figures.

Prompt provider 202 may receive prompt generation input, and output prompt templates. As will be discussed in more detail below, prompt generation input may include fields that may be determined based on an entity type that is associated with a record. For example, records may be associated with leads, cases, or other entities. Prompt provider 202 may generate fields based on the entity type. These fields may be fields that may appear in the record or may be extra data that is generated for additional insights for the record. Then, the fields are used to generate prompt templates that are provided to generative model system 204.

The prompt templates may require input that adds context to the prompt templates. Context provider 206 may receive context generation input, and output context information for the prompt templates. In some embodiments, the context may be values that are determined from values for fields of the record or related records, or other related information. The generation of the context will be described in more detail below. The context may be provided to generative model system 204. Then, generative model system 204 may generate prompts using the prompt templates from prompt provider 202 and the context from context provider 206. Generative model system 204 inputs the generated prompts into one or more generative models. The output of the generative model or models may be a generated result that is based on the prompts that are input. Depending on the prompts input, the generated results may be different.

Record enrichment system 208 receives the generated result. Record enrichment system 208 may use the generated result to determine enrichment data for the record. For example, record enrichment system 208 may determine fields for the record and enrichment data for the fields. Record enrichment system 208 then passes the enrichment data to user interface 112 for display in the record. A user can review the enrichment data, edit the enrichment data, accept the enrichment data, delete the enrichment data, or perform other actions.

The following will now describe the entities in FIG. 2 in more detail.

### Prompt Provider

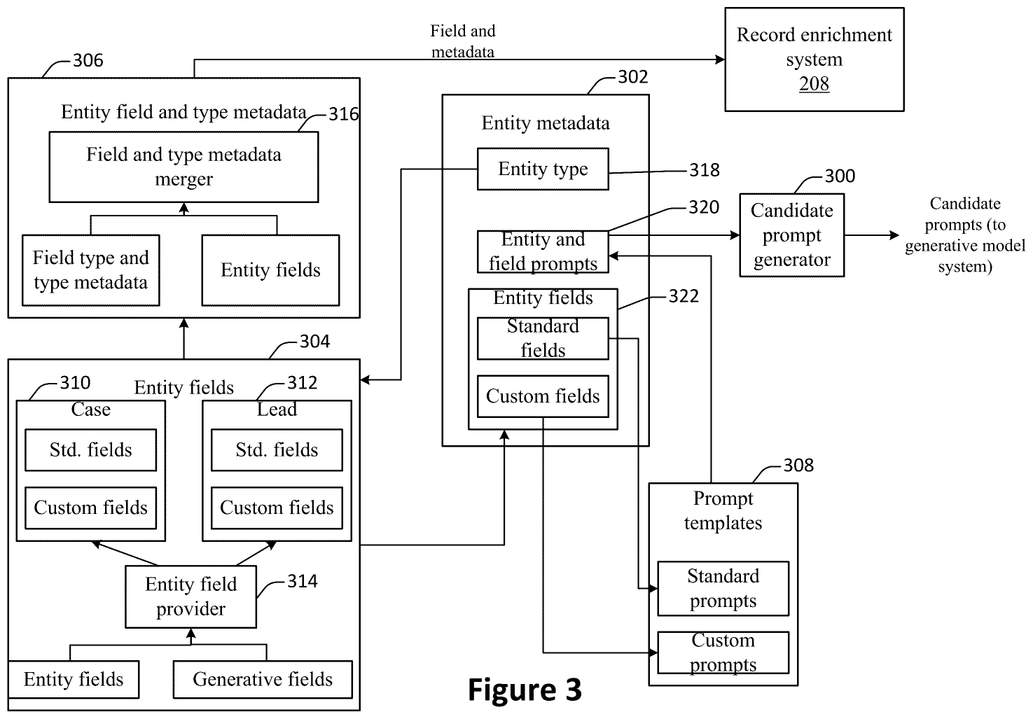

FIG. 3 depicts a more detailed example of prompt provider 202 according to some embodiments. A user may browse a record on user interface 112. For example, a user may retrieve or create a record for display on user interface 112. The display of the record may trigger the data enrichment process to run. Other triggers may also be used, such as data enrichment may be performed over different time periods, such as on a schedule (e.g., daily, monthly, etc.). Also, when data is changed on a record, the data enrichment process may be run.

Entity metadata 302 may be determined for the record. For example, the metadata may describe an entity type 318, which may be a type of the record. For example, the record may be based on different entity types offered by management system 106, such as leads, cases, etc.

Entity fields 304 may store fields for different entity types. For example, prompt provider 202 may determine the entity type for the record, such as comparing the entity metadata to a case entity type, a lead entity type, or other entity types. Depending on the respective entity type, different standard fields and custom fields may be used. For example, an entity field provider 314 may store entity fields and generative fields. Entity fields may be standard fields and custom fields for an entity type. Each entity type may have different standard fields and custom fields because the entity types may have different fields and different information. For example, a lead entity type may have different information than a case. Generative fields may be fields allowed for generative services. For example, not all fields may be used in the generative process . . . . Also, the generative fields may add fields for use in generative services, such as fields that are determined to be helpful to generate good results from the generative model. The standard fields may be defined and used by management system 106 for multiple companies. The custom fields that may be defined by a company, and may be different for each company. Entity field provider 314 may look up the entity fields and the generative fields based on the entity type. For example, a query for fields that are associated with the entity type is used to retrieve the fields. Then, an intersection of the two sets of fields may generate a prompt-ready field set.

In some embodiments, for the case entity type, standard fields may include a case type, a case product, a case next steps, a case settlement, etc. Custom fields may include fields defined by the customer. For the lead entity type, the standard fields may be for a lead company, a lead annual revenue, a lead number of employees, a lead industry, a lead website. Custom fields may also be defined by the customer for the leads and may be the competitors, marketcap, and CDP environmental score. Each of the fields may be based on the entity type and how the entity is used. For example, leads are used to store information for potential customers.

Prompt provider 202 prepares the prompt-ready field set for prompt template generation. For example, entity fields 322 in entity metadata 302 may be prepared to be used to look up prompt templates from prompt templates 308. The standard fields may be used to look up standard prompt templates from prompt templates 308. Also, the custom fields may be used to look up custom prompt templates from prompt templates 308. For example, a mapping from standard fields to standard prompt templates and a mapping from custom fields to customer defined prompt templates may be used. In some embodiments, custom prompt templates may override standard prompt templates if there is overlap. The prompt templates are used to determine entity and field prompts 320. The entity level prompt templates may be prompt templates for the entity type. The field level prompt templates may be the prompt templates based on the fields that were associated with the entity type. In some examples, the field of lead industry may retrieve a prompt template of “How many employees does {!Lead.Company} have?”. {!Lead.Company} is a variable in which a context could be inserted. The field level prompts refer to the generated result of the prompts that may serve for backfilling a specific field on the record. Entity-level prompts refer to the generated result of the prompts and may serve as generated information for the record without backfilling a field. Examples of entity level prompts include ‘Lead.Competitor’: ‘What are competitors in the US market for {!Lead.Company}?’, and ‘Lead.Competitor’: ‘What are stock price today for {!Lead.Company}?. Other examples will be described below.

A candidate prompt generator 300 may generate the prompt templates for input into generative model system 204. In some embodiments, candidate prompt generator 300 may convert the prompt templates into a format that can be processed by generative model system 204. For example, the prompts may be converted into a JSON string, but other formats may be used.

An example of standard prompt templates is shown below. For each standard field, an associated prompt template is provided. The prompt templates include text and variables. For example, for the field Lead. Intro, the prompt template is “what does {!Lead.Company} do and is famous for?”. A variable of {!Lead.Company} will have a value inserted based on a determined context. The following includes examples of prompt templates lead and case entity types in a format, such as JSON:

```
[
  {
    ‘Lead.Intro’: ‘What does {!Lead.Company} do and is
famous for?’,
    ‘Lead.Opportunity’: ‘What are the sales opportunities
with {!Lead.title} in {!Lead.Copmany}’,
    ‘Lead.Industry’: ‘What is the industry for
{!Lead.Company}?’,
    ‘Lead.Website’: ‘What is the website for
{!Lead.Company}?’,
    ‘Lead.AnnualRevenue’: ‘What is the annual revenue for
{!Lead.Company}?’,
    ‘Lead.NumberOfEmployees': ‘What is the employees in
{!Lead.Company} in the integer format?’
  },
  {
    ‘Case.Type’: ‘Classify the type of this customer case
given types {!PICKVAL(Case.Type)} based on
{!CONTEXT(Case.Record)}.’,
    ‘Case.Product’: ‘Predict the product that customer
talks about in this case given products
{!PICKVAL(Case.Product)} based on {!CONTEXT(Case.Record)}.’,
  }
]
```

The prompt templates for a lead entity type are shown for fields Lead. Intro, Lead.Opportunity, Lead. Industry, Lead. Website, Lead.AnnualRevenue, and

Lead.NumberofEmployees. Each field includes a prompt template that includes text and also variables with the format of {!variable}. Prompt templates for case entities are also shown for the fields Case. Type and Case.Product. The variables may also be picklist variables in which a value in a picklist is selected for the variable.

Additionally, Table 1 shows an example of custom prompt templates that are generated for custom fields. The custom prompt templates may also include text and variables. The prompt templates may be customized the company. For example, for a lead website custom field, the prompt may be “what is the Europe website for {!Lead.Company}?”. The term “Europe” may be added as a custom term in the prompt template because the company has leads in Europe. The variable !Lead.Company may be filled in using a context that will be determined. Other custom prompt templates are provided for other custom fields for the lead entity type and case entity type. The other lead prompt templates are for marketcap and CDP environmental scores. The case custom prompt template is used to determine a sentiment of the customer based on a context of the record. The columns of isOverride may indicate whether the custom prompt template should override a standard prompt template for the same field. The column isActive indicates whether the custom field is active and used (TRUE), or not active and not used (FALSE). The version is the version number of the prompt template.

TABLE 1

| Entity | Field | IsOverride | IsActive | Version | Prompt template |
|---|---|---|---|---|---|
| Lead | Website | TRUE | TRUE | 2 | ′What is the Europe |
| | | | | | website for |
| | | | | | {!Lead.Company}?′ |
| Lead | MktCap_c | FALSE | TRUE | 1 | ′What is the market |
| | | | | | cap for |
| | | | | | {!Lead.Company}?′ |
| Lead | CdpScore_c | FALSE | FALSE | 2 | ′What is the Dis- |
| | | | | | closure Insight |
| | | | | | Action score for |
| | | | | | {!Lead.Company} |
| | | | | | according to |
| | | | | | cdp.net?′ |
| Case | Sentiment_c | FALSE | TRUE | 1 | ′Classify the |
| | | | | | customer |
| | | | | | sentiment as |
| | | | | | positive, neutral |
| | | | | | or negative based |
| | | | | | on {!CONTEXT |
| | | | | | (Case.Record)}.″ |

### Context Generation

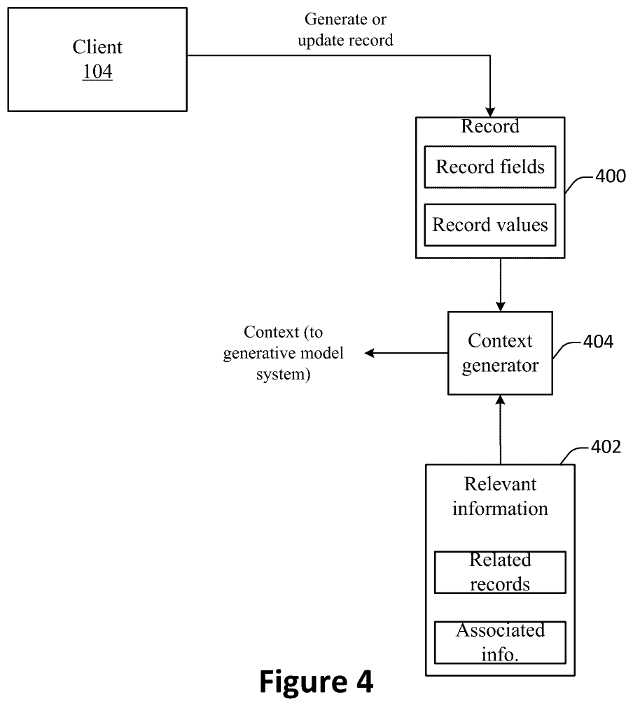

FIG. 4 depicts a more detailed example of context provider 206 according to some embodiments. A context generator 404 may receive a record 400 and relevant information 402. For example, a user may interact, such as browse, generate, update, or create, with a record in client 104. The interaction may trigger the generative data enrichment process. Also, an input to perform the generative data enrichment process may be received or the process may be performed automatically without an input.

The record may include record fields and record values. For example, record field/value pairs may be provided to context generator 404. For example, a field may include company name, and a value may be the company name of Company X.

Relevant information 402 may include information from related records and associated information. The relevant information may be associated with the record, and may include related records and associated information. The related records may be structured information from other records that are linked to this record. The associated information may be unstructured information, such as information captured from the internet or other searches based on the record.

Context generator 404 receives the information from record 400 and relevant information 402. Then, context generator 404 can generate a context that is provided to generative model system 204. For example, context generator 404 may provide the context as field/value pairs, the related records, and the associated information in a format.

The “related records” may refer to the connections or associations between data entries in tables, such as in a relational database. These relationships are established using keys, such as primary keys and foreign keys, to link records across tables. The “relevant information” may refer to the data that is related to a specific query or operation being performed. Unlike relational databases that enforce a predefined schema and rigid structure, unstructured databases are designed to be highly flexible and scalable, allowing for the storage and retrieval of large volumes of unstructured or semi-structured data. The “relevant” email content in unstructured databases can be associated to a Lead record in relational databases via look-up key.

In some embodiments, given a lead record, the related records may include opportunity records in CRM system 106. The opportunity records represent opportunities for the lead. Also, given a case record, the related records may include case comment records in CRM system 106 that include comments for the case, and email content in CRM system 106 that may include emails associated with the case. The email content may be associated information and the case comment records may be related records.

### Generative Data Generation

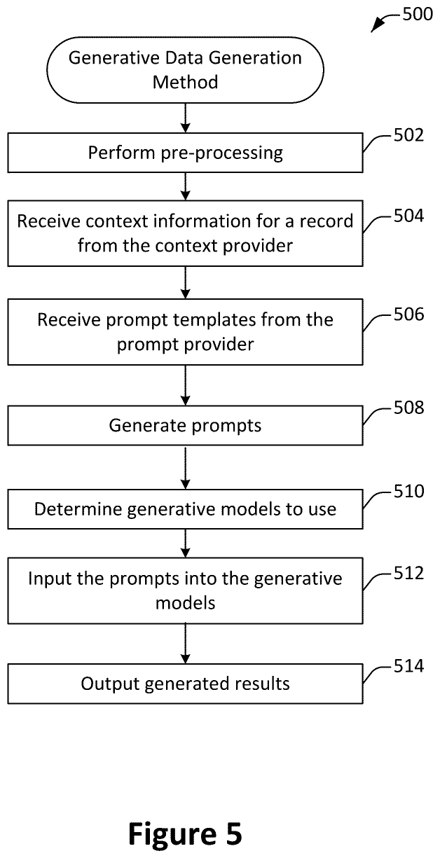

FIG. 5 is simplified flow chart 500 for generating enrichment data according to some embodiments. Generative model system 204 may perform the method to generate results for enriching data of a record. At 502, generative model system 204 may pre-process data. Data pre-processing may prepare data for prompt generation. The pre-processing may include data decryption (if data was encrypted in database), data de-identification by removing personally identifiable information (PII) from datasets to protect privacy and confidentiality, data transformation by converting data from one format to another to make it suitable for analysis, and data reduction (if data volume is larger than service can handle given the Service Level Agreement (SLA)).

At 504, generative model system 204 retrieves context information for the record from context provider 206. At 506, generative model system 204 receives prompt templates from prompt provider 202. Then, at 508, generative model system 204 generates prompts from the prompt templates and context information. For example, generative model system 204 may determine variables in the prompt templates in which context information can be inserted. For example, a variable of !Lead.CompanyName may have an associated context for the company name and generative model system 204 determines the company name of Company X from the context information. Then, generative model system 204 inserts the company name of Company X for the variable. The insertion of the context may generate complete prompts that may provide better generated results. For example, the insertion of the name Company X may produce a better result compared to if a generic term of “company” is used instead of a specific name.

At 510, generative model system 204 determines generative models to use. For example, multiple generative models may be available. Generative model system 204 may determine which generative models to use. In some embodiments, the record may be analyzed to determine which generative models might be better to use to determine results.

At 512, generative model system 204 inputs the prompts into the selected generative models. At 514, generative model system 204 outputs generated results from the generative models. For examples, the generative models have been trained to output text based on the text of the prompts. One example of the generated result may be shown as follows:

```
{
  ‘Lead.Industry’ : ‘Innovative, cutting-edge, technology leader.’,
  ‘Lead.Website’ : ‘https://www.companynameX.com’,
  ‘Lead.NumberOfEmployees' : ‘118,000’,
}
```

In the above, the field “Lead. Industry” has the associated generated result of “innovative, cutting edge, technology leader.”, the field “Lead. Website” has the associated website of “www.companynameX.com”, and the field “Lead. NumberOfEmployees” has the number of “118,000”. These results may have been improved by inserting the context of Company name X into the prompts because the results included more accurate data, such as the website link or number of employees. Large language model system 204 provides the generated result to record enrichment system 208.

### Data Enrichment

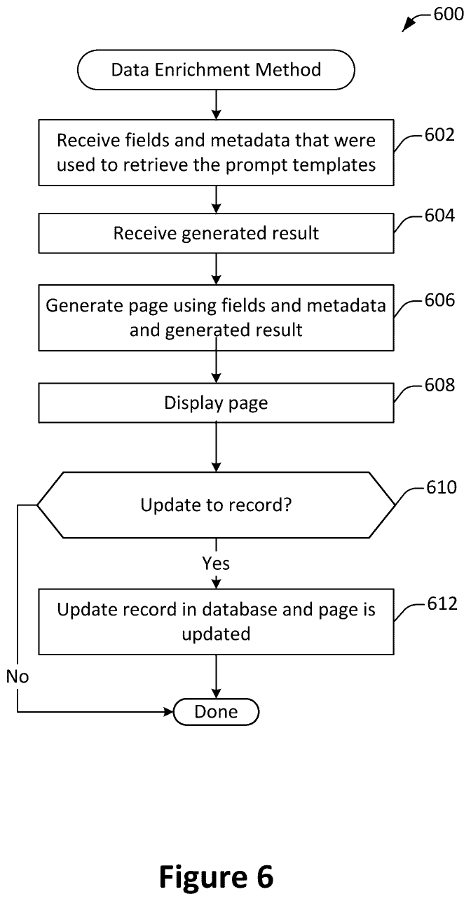

FIG. 6 depicts a simplified flow chart 600 of a method for enriching a record with data generated by generative model system 204 according to some embodiments. At 602, record enrichment system 208 receives fields and metadata that were used to retrieve the prompt templates. The fields may be the fields that are associated with the entity type of the record. Also, the field may have various metadata that is displayed to the user. The displayable fields may be subject to field level security settings. For example, not all entity fields may be accessible by all users.

At 604, record enrichment system 208 receives the generated result. At 606, record enrichment system 208 generates a page using the fields and metadata. The page may include fields and associated values, and any metadata for the fields. There may be some fields that do not have values or may have inaccurate values. Record enrichment system 208 may generate enrichment data from the generated result for the page. For example, the generated result may be associated with certain fields in the page. Record enrichment system 208 may generate enrichment data from generated results for certain fields in the page. In some examples, record enrichment system 208 may determine the standard and custom fields on the record. Then, record enrichment system 208 may determine values from the generated result for the standard fields or custom fields. In other examples, record enrichment system 208 may determine mismatched values from the values for a value of a field and a value from the generated result. Record enrichment system 208 may highlight the mismatched values.

At 608, record enrichment system 208 displays the page in user interface 112. A user may review the fields with the enrichment data, make any necessary changes, or accept the changes. At 610, record enrichment system 208 determines whether to update the record. For example, an input to accept the enrichment data is received. If so, at 612, the record is updated in the database and also the page may be updated.

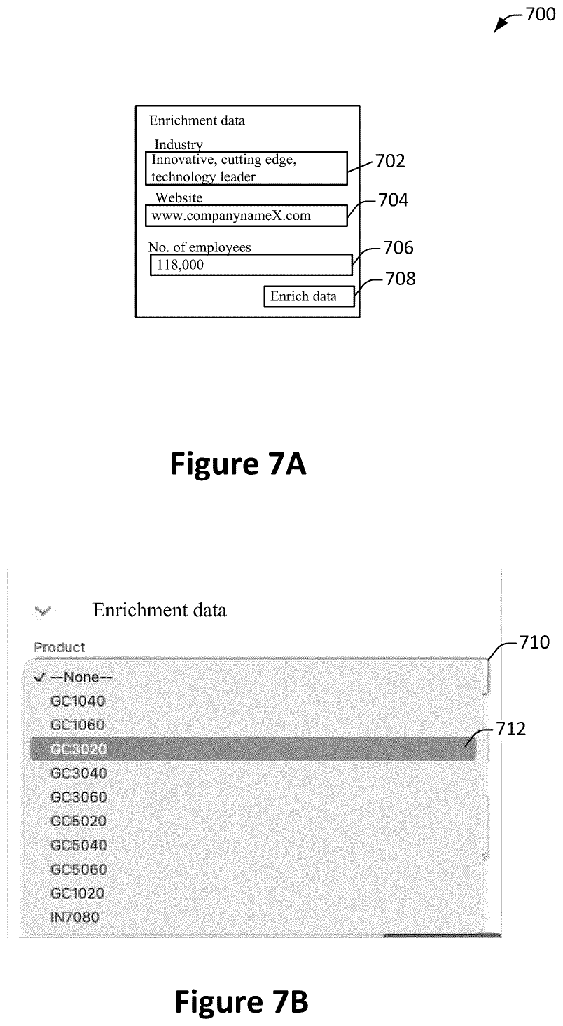

FIG. 7A depicts an example of a portion of a page with fields and enrichment data according to some embodiments. At 700, enrichment data for fields 702, 704, and 706 is displayed. For example, at 702, an industry field has the text “innovative, cutting edge, technology leader.”. At 704, the website field has “www.companynameX.com” inserted, and at 706, for a number of employees field, the value of “118,000” is inserted. A user can choose to accept the enriched data by selecting a button 708 that may accept the changes to enrich the data.

FIG. 7B depicts an example of enriching a picklist field according to some embodiments. At 710, a picklist for a field is available. The generated result may indicate the value of the picklist is “GC3020”. At 712, record enrichment system 708 may select the value for the field of product.

### Interface Examples

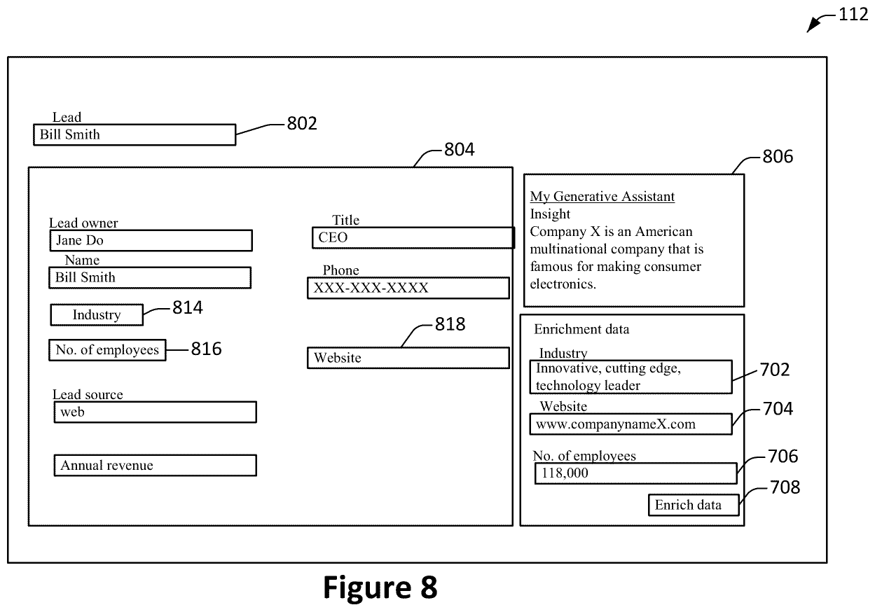

FIG. 8 depicts an example of a page 800 for a record according to some embodiments. The page may be for a lead record of a lead for Bill Smith as shown at 802 that is owned by Jane Doe. The page includes details 804 with fields. A first instance of enrichment data may be shown at 806. This enrichment data may provide relevant information for a company associated with the lead, such an insight into the company of the lead. Also, a second instance of enrichment data for fields of Industry, Website, and No. of employees is shown at 702, 704, and 706. The enrichment data may correspond to fields in the record at 814, 816, and 818, respectively. A user can choose to accept the enrichment data at a button 708, and the enrichment data may be automatically inserted in the fields at 814, 816, and 818, respectively, and also stored in database system 102.

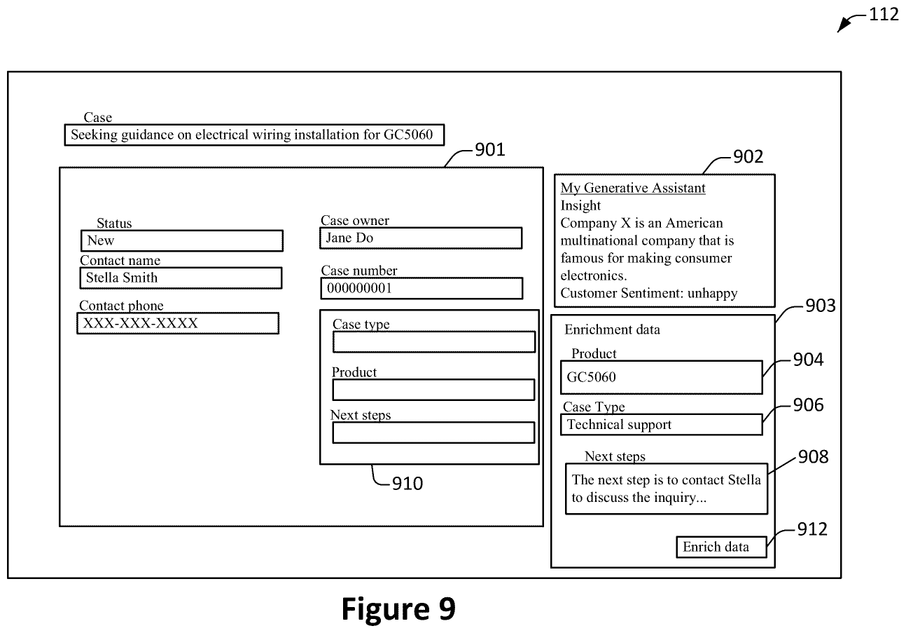

FIG. 9 depicts an example of user interface 112 for a case record according to some embodiments. The case may be seeking guidance on electrical wiring installation for a part. GC5060. The details of the case may be shown at 901. At 902, a first instance of enrichment data for a company that is associated with the case is provided. The enrichment data may include a case summary that has been determined from the generated result and also a customer sentiment. The customer sentiment may indicate the sentiment of the customer based on information from the record and/or enrichment data, such as the customer is listed as unhappy in this case. For example, the prompt may have asked “what is the customer sentiment for these case?”, and the output was “unhappy”. Also, a second instance of enrichment data at 903 is shown. For example, a picklist value for the product has been generated as enrichment data and selected at 904 based on the generated result. At 906, the case type has been selected from a picklist as technical support from the generated result. And, at 908, a next step has been suggested from the generated result for contacting Stella to discuss the inquiry. The product, case type, and next steps may be inserted in fields shown at 910 of the record if desired by the user. For example, a user can select an enriched data button at 912 to insert the data in the record on interface 112, and also store the data in database system 102. The user can also edit the values provided by changing some values, such as selecting a new picklist value or editing the company name, etc.

### CONCLUSION

Accordingly, a system to generate prompts for a generative model is provided for a CRM system. The prompts are generated to provide a generated result that can be used to enrich data for a record in the CRM system. The method of generating the prompts may improve the prompts that are generated to generate results that are relevant for the records in the CRM system. Accordingly, the generated result may improve the CRM system.

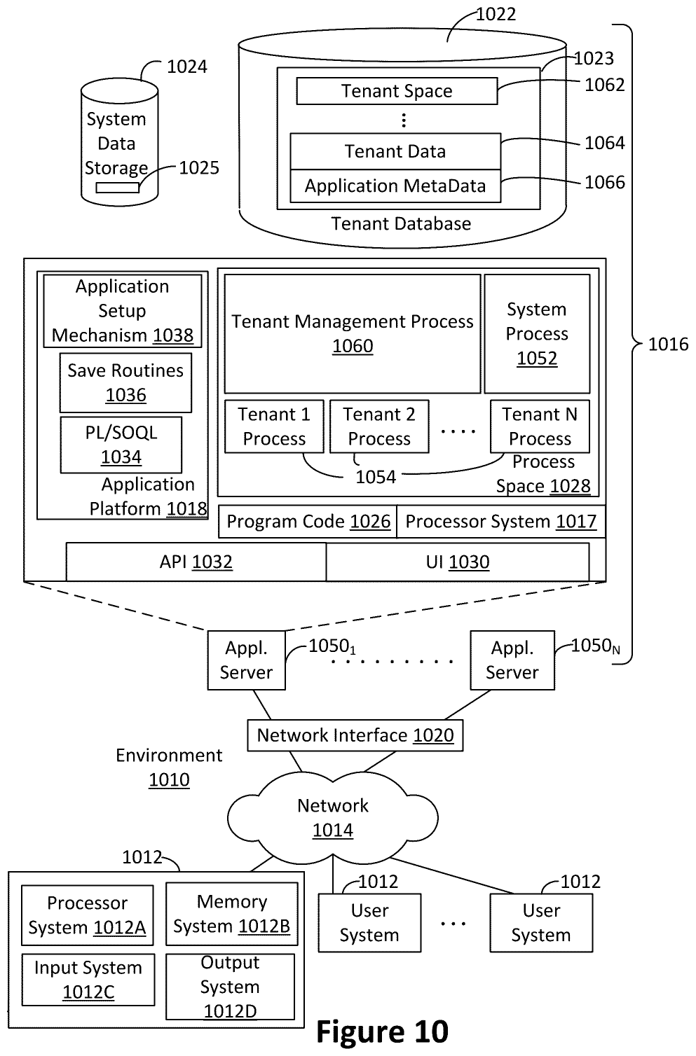

FIG. 10 shows a block diagram of an example of an environment 1010 that includes an on-demand database service configured in accordance with some implementations. Environment 1010 may include user systems 1012, network 1014, database system 1016, processor system 1017, application platform 1018, network interface 1020, tenant data storage 1022, tenant data 1023, system data storage 1024, system data 1025, program code 1026, process space 1028, User Interface (UI) 1030, Application Program Interface (API) 1032, PL/SOQL 1034, save routines 1036, application setup mechanism 1038, application servers 1050-1 through 1050-N, system process space 1052, tenant process spaces 1054, tenant management process space 1060, tenant storage space 1062, user storage 1064, and application metadata 1066. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 1016, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 1018 may be a framework that allows the creation, management, and execution of applications in system 1016. Such applications may be developed by the database service provider or by users or third-party application developers accessing the service. Application platform 1018 includes an application setup mechanism 1038 that supports application developers' creation and management of applications, which may be saved as metadata into tenant data storage 1022 by save routines 1036 for execution by subscribers as one or more tenant process spaces 1054 managed by tenant management process 1060 for example. Invocations to such applications may be coded using PL/SOQL 1034 that provides a programming language style interface extension to API 1032. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 1066 for a subscriber making such an invocation. Such system processes may also manage execution of application metadata 1066 as an application in a virtual machine.

In some implementations, each application server 1050 may handle requests for any user associated with any organization. A load balancing function (e.g., an F5 Big-IP load balancer) may distribute requests to the application servers 1050 based on an algorithm such as least-connections, round robin, observed response time, etc. Each application server 1050 may be configured to communicate with tenant data storage 1022 and the tenant data 1023 therein, and system data storage 1024 and the system data 1025 therein to serve requests of user systems 1012. The tenant data 1023 may be divided into individual tenant storage spaces 1062, which can be either a physical arrangement and/or a logical arrangement of data. Within each tenant storage space 1062, user storage 1064 and application metadata 1066 may be similarly allocated for each user. For example, a copy of a user's most recently used (MRU) items might be stored to user storage 1064. Similarly, a copy of MRU items for an entire tenant organization may be stored to tenant storage space 1062. A UI 1030 provides a user interface and an API 1032 provides an application programming interface to system 1016 resident processes to users and/or developers at user systems 1012.

System 1016 may implement a web-based generative data enrichment system. For example, in some implementations, system 1016 may include application servers configured to implement and execute generative data enrichment system software applications. The application servers may be configured to provide related data, code, forms, web pages and other information to and from user systems 1012. Additionally, the application servers may be configured to store information to, and retrieve information from a database system. Such information may include related data, objects, and/or Webpage content. With a multi-tenant system, data for multiple tenants may be stored in the same physical database object in tenant data storage 1022, however, tenant data may be arranged in the storage medium(s) of tenant data storage 1022 so that data of one tenant is kept logically separate from that of other tenants. In such a scheme, one tenant may not access another tenant's data, unless such data is expressly shared.

Several elements in the system shown in FIG. 10 include conventional, well-known elements that are explained only briefly here. For example, user system 1012 may include processor system 1012A, memory system 1012B, input system 1012C, and output system 1012D. A user system 1012 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 1012 to access, process and view information, pages and applications available from system 1016 over network 1014. Network 1014 may be any network or combination of networks of devices that communicate with one another, such as any one or any combination of a LAN (local area network), WAN (wide area network), wireless network, or other appropriate configuration.

The users of user systems 1012 may differ in their respective capacities, and the capacity of a particular user system 1012 to access information may be determined at least in part by “permissions” of the particular user system 1012. As discussed herein, permissions generally govern access to computing resources such as data objects, components, and other entities of a computing system, such as a generative data enrichment system, a social networking system, and/or a CRM database system. “Permission sets” generally refer to groups of permissions that may be assigned to users of such a computing environment. For instance, the assignments of users and permission sets may be stored in one or more databases of System 1016. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 1016 may provide on-demand database service to user systems 1012 using an MTS arrangement. By way of example, one tenant organization may be a company that employs a sales force where each salesperson uses system 1016 to manage their sales process. Thus, a user in such an organization may maintain contact data, leads data, customer follow-up data, performance data, goals and progress data, etc., all applicable to that user's personal sales process (e.g., in tenant data storage 1022). In this arrangement, a user may manage his or her sales efforts and cycles from a variety of devices, since relevant data and applications to interact with (e.g., access, view, modify, report, transmit, calculate, etc.) such data may be maintained and accessed by any user system 1012 having network access.

When implemented in an MTS arrangement, system 1016 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 1016 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 1016 may also maintain system-level data usable by multiple tenants or other data. Such system-level data may include industry reports, news, postings, and the like that are sharable between tenant organizations.

In some implementations, user systems 1012 may be client systems communicating with application servers 1050 to request and update system-level and tenant-level data from system 1016. By way of example, user systems 1012 may send one or more queries requesting data of a database maintained in tenant data storage 1022 and/or system data storage 1024. An application server 1050 of system 1016 may automatically generate one or more SQL statements (e.g., one or more SQL queries) that are designed to access the requested data. System data storage 1024 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

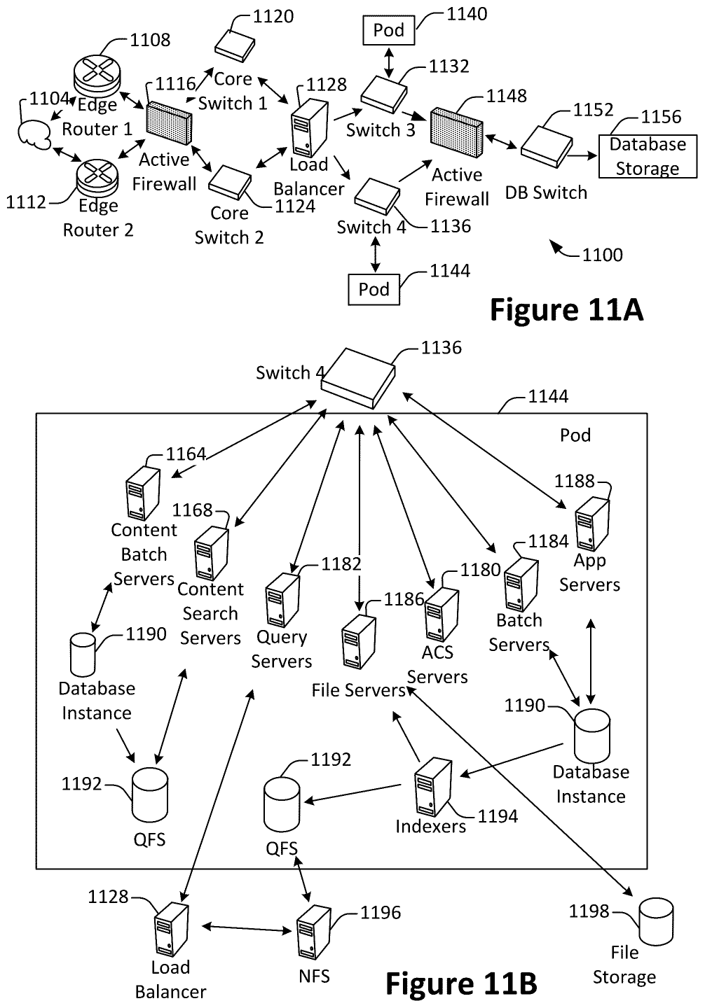

FIG. 11A shows a system diagram of an example of architectural components of an on-demand database service environment 1100, configured in accordance with some implementations. A client machine located in the cloud 1104 may communicate with the on-demand database service environment via one or more edge routers 1108 and 1112. A client machine may include any of the examples of user systems 1012 described above. The edge routers 1108 and 1112 may communicate with one or more core switches 1120 and 1124 via firewall 1116. The core switches may communicate with a load balancer 1128, which may distribute server load over different pods, such as the pods 1140 and 1144 by communication via pod switches 1132 and 1136. The pods 1140 and 1144, which may each include one or more servers and/or other computing resources, may perform data processing and other operations used to provide on-demand services. Components of the environment may communicate with a database storage 1156 via a database firewall 1148 and a database switch 1152.

Accessing an on-demand database service environment may involve communications transmitted among a variety of different components. The environment 1100 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 11A and 11B.

The cloud 1104 refers to any suitable data network or combination of data networks, which may include the Internet. Client machines located in the cloud 1104 may communicate with the on-demand database service environment 1100 to access services provided by the on-demand database service environment 1100. By way of example, client machines may access the on-demand database service environment 1100 to retrieve, store, edit, and/or process generative data enrichment system information.

In some implementations, the edge routers 1108 and 1112 route packets between the cloud 1104 and other components of the on-demand database service environment 1100. The edge routers 1108 and 1112 may employ the Border Gateway Protocol (BGP). The edge routers 1108 and 1112 may maintain a table of IP networks or ‘prefixes’, which designate network reachability among autonomous systems on the internet.

In one or more implementations, the firewall 1116 may protect the inner components of the environment 1100 from internet traffic. The firewall 1116 may block, permit, or deny access to the inner components of the on-demand database service environment 1100 based upon a set of rules and/or other criteria. The firewall 1116 may act as one or more of a packet filter, an application gateway, a stateful filter, a proxy server, or any other type of firewall.

In some implementations, the core switches 1120 and 1124 may be high-capacity switches that transfer packets within the environment 1100. The core switches 1120 and 1124 may be configured as network bridges that quickly route data between different components within the on-demand database service environment. The use of two or more core switches 1120 and 1124 may provide redundancy and/or reduced latency.

In some implementations, communication between the pods 1140 and 1144 may be conducted via the pod switches 1132 and 1136. The pod switches 1132 and 1136 may facilitate communication between the pods 1140 and 1144 and client machines, for example via core switches 1120 and 1124. Also or alternatively, the pod switches 1132 and 1136 may facilitate communication between the pods 1140 and 1144 and the database storage 1156. The load balancer 1128 may distribute workload between the pods, which may assist in improving the use of resources, increasing throughput, reducing response times, and/or reducing overhead. The load balancer 1128 may include multilayer switches to analyze and forward traffic.

In some implementations, access to the database storage 1156 may be guarded by a database firewall 1148, which may act as a computer application firewall operating at the database application layer of a protocol stack. The database firewall 1148 may protect the database storage 1156 from application attacks such as structure query language (SQL) injection, database rootkits, and unauthorized information disclosure. The database firewall 1148 may include a host using one or more forms of reverse proxy services to proxy traffic before passing it to a gateway router and/or may inspect the contents of database traffic and block certain content or database requests. The database firewall 1148 may work on the SQL application level atop the TCP/IP stack, managing applications' connection to the database or SQL management interfaces as well as intercepting and enforcing packets traveling to or from a database network or application interface.

In some implementations, the database storage 1156 may be an on-demand database system shared by many different organizations. The on-demand database service may employ a single-tenant approach, a multi-tenant approach, a virtualized approach, or any other type of database approach. Communication with the database storage 1156 may be conducted via the database switch 1152. The database storage 1156 may include various software components for handling database queries. Accordingly, the database switch 1152 may direct database queries transmitted by other components of the environment (e.g., the pods 1140 and 1144) to the correct components within the database storage 1156.

FIG. 11B shows a system diagram further illustrating an example of architectural components of an on-demand database service environment, in accordance with some implementations. The pod 1144 may be used to render services to user(s) of the on-demand database service environment 1100. The pod 1144 may include one or more content batch servers 1164, content search servers 1168, query servers 1182, file servers 1186, access control system (ACS) servers 1180, batch servers 1184, and app servers 1188. Also, the pod 1144 may include database instances 1190, quick file systems (QFS) 1192, and indexers 1194. Some or all communication between the servers in the pod 1144 may be transmitted via the switch 1136.

In some implementations, the app servers 1188 may include a framework dedicated to the execution of procedures (e.g., programs, routines, scripts) for supporting the construction of applications provided by the on-demand database service environment 1100 via the pod 1144. One or more instances of the app server 1188 may be configured to execute all or a portion of the operations of the services described herein.

In some implementations, as discussed above, the pod 1144 may include one or more database instances 1190. A database instance 1190 may be configured as an MTS in which different organizations share access to the same database, using the techniques described above. Database information may be transmitted to the indexer 1194, which may provide an index of information available in the database 1190 to file servers 1186. The QFS 1192 or other suitable filesystem may serve as a rapid-access file system for storing and accessing information available within the pod 1144. The QFS 1192 may support volume management capabilities, allowing many disks to be grouped together into a file system. The QFS 1192 may communicate with the database instances 1190, content search servers 1168 and/or indexers 1194 to identify, retrieve, move, and/or update data stored in the network file systems (NFS) 1196 and/or other storage systems.

In some implementations, one or more query servers 1182 may communicate with the NFS 1196 to retrieve and/or update information stored outside of the pod 1144. The NFS 1196 may allow servers located in the pod 1144 to access information over a network in a manner similar to how local storage is accessed. Queries from the query servers 1122 may be transmitted to the NFS 1196 via the load balancer 1128, which may distribute resource requests over various resources available in the on-demand database service environment 1100. The NFS 1196 may also communicate with the QFS 1192 to update the information stored on the NFS 1196 and/or to provide information to the QFS 1192 for use by servers located within the pod 1144.

In some implementations, the content batch servers 1164 may handle requests internal to the pod 1144. These requests may be long-running and/or not tied to a particular customer, such as requests related to log mining, cleanup work, and maintenance tasks. The content search servers 1168 may provide query and indexer functions such as functions allowing users to search through content stored in the on-demand database service environment 1100. The file servers 1186 may manage requests for information stored in the file storage 1198, which may store information such as documents, images, basic large objects (BLOBs), etc. The query servers 1182 may be used to retrieve information from one or more file systems. For example, the query system 1182 may receive requests for information from the app servers 1188 and then transmit information queries to the NFS 1196 located outside the pod 1144. The ACS servers 1180 may control access to data, hardware resources, or software resources called upon to render services provided by the pod 1144. The batch servers 1184 may process batch jobs, which are used to run tasks at specified times. Thus, the batch servers 1184 may transmit instructions to other servers, such as the app servers 1188, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

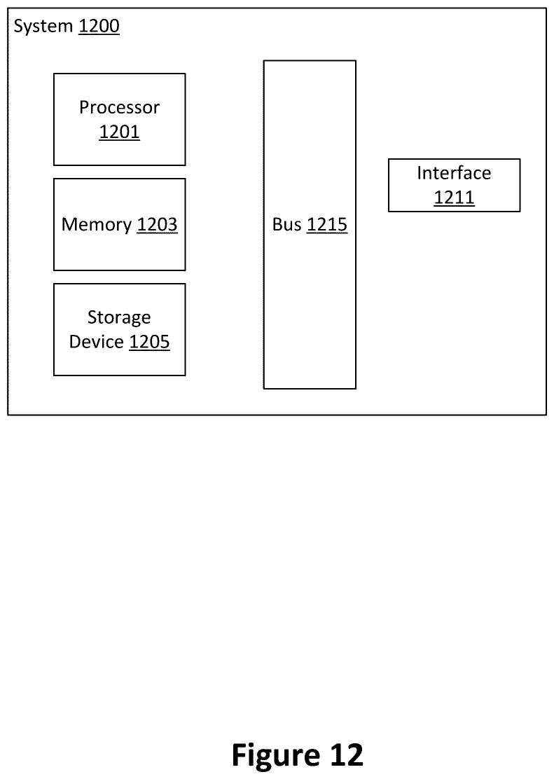

FIG. 12 illustrates one example of a computing device. According to various embodiments, a system 1200 suitable for implementing embodiments described herein includes a processor 1201, a memory module 1203, a storage device 1205, an interface 1211, and a bus 1215 (e.g., a PCI bus or other interconnection fabric.) System 1200 may operate as variety of devices such as an application server, a database server, or any other device or service described herein. Although a particular configuration is described, a variety of alternative configurations are possible. The processor 1201 may perform operations such as those described herein. Instructions for performing such operations may be embodied in the memory 1203, on one or more non-transitory computer readable media, or on some other storage device. Various specially configured devices can also be used in place of or in addition to the processor 1201. The interface 1211 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
selecting, by a computing device, a set of fields in which data can be populated, wherein the set of fields are associated with a record in a database system;
retrieving, by the computing device, a set of prompt templates that is associated with the set of fields, wherein a respective prompt template is retrieved for a respective field and comprises human-readable text and a variable in which context information can be inserted;
searching, by the computing device, information that is associated with the record to determine context information, wherein context information includes values that are determined from values for the set of fields;
inserting, by the computing device, the context information into variables in the prompt templates to generate a set of prompts for the set of fields, wherein prompts in the set of prompts include the human-readable text with the context information inserted in place of the variables;
inputting, by the computing device, the set of prompts into a generative model to output a generated result, wherein the generative model is trained to output human-readable text based on the set of prompts as the generated result; and
outputting, by the computing device, enrichment data for the record on an interface, wherein the enrichment data is based on the human-readable text of the generated result.

2. The method of claim 1, wherein selecting the set of fields for the record comprises:
determining an entity type that is associated with the record, wherein the entity type is based on a type of records that can be stored in the database system; and
selecting the set of fields based on the entity type.

3. The method of claim 2, wherein:
a first field in the set of fields is standard for multiple companies, and
a second field in the set of fields is customized for a company that is associated with the record.

4. The method of claim 3, wherein retrieving the set of prompt templates comprises:
retrieving a standard prompt template for the first field, and
retrieving a custom prompt template for the second field, wherein the custom prompt is associated with the company.

5. The method of claim 1, wherein the variable is configured to be replaced by context information.

6. The method of claim 1, wherein searching information that is associated with the record to determine context information comprises:
determining record values for fields in the record; and
using the record values to generate the context information.

7. The method of claim 1, wherein searching information that is associated with the record to determine context information comprises:
determining relevant information based on the record, and
using the relevant information to generate the context information.

8. The method of claim 7, wherein the relevant information is based on related records to the record or associated information for the record.

9. The method of claim 1, wherein:
the context information comprises a variable name and a value for the variable, and
the value is inserted into a prompt template in place of the variable.

10. The method of claim 1, further comprising:
selecting one or more generative models to use; and
inputting the set of prompts into the one or more generative models to generate a set of generated results from the one or more generative models.

11. The method of claim 1, wherein outputting the enrichment data for the record comprises:
outputting the enrichment data in a portion of the interface, wherein the enrichment data corresponds to one or more fields being displayed in the interface.

12. The method of claim 1, wherein outputting the enrichment data for the record comprises:
outputting the enrichment data in a portion of the interface as a supplement to the record.

13. The method of claim 1, further comprising:
receiving an input to accept at least a portion the enrichment data; and
populating at least a portion of the fields in the one or more fields in the record with the at least the portion of the enrichment data.

14. The method of claim 1, wherein:
the enrichment data is listed with the set of fields in a first portion of the interface, and
the set of fields is shown in a second portion of the interface for the record.

15. The method of claim 1, wherein:
the enrichment data selects a value for a field in the set of fields.

16. A non-transitory computer-readable storage medium having stored thereon computer executable instructions, which when executed by a computing device, cause the computing device to be operable for:
selecting a set of fields in which data can be populated, wherein the set of fields are associated with a record in a database system;
retrieving a set of prompt templates that is associated with the set of fields, wherein a respective prompt template is retrieved for a respective field and comprises human-readable text and a variable in which context information can be inserted;
searching information that is associated with the record to determine context information, wherein context information includes values that are determined from values for the set of fields;
inserting the context information into variables in the prompt templates to generate a set of prompts for the set of fields, wherein prompts in the set of prompts include the human-readable text with the context information inserted in place of the variables;
inputting the set of prompts into a generative model to output a generated result, wherein the generative model is trained to output human-readable text based on the set of prompts as the generated result; and
outputting enrichment data for the record on an interface, wherein the enrichment data is based on the human-readable text of the generated result.

17. The non-transitory computer-readable storage medium of claim 16, wherein selecting the set of fields for the record comprises:
determining an entity type that is associated with the record, wherein the entity type is based on a type of records that can be stored in the database system; and
selecting the set of fields based on the entity type.

18. The non-transitory computer-readable storage medium of claim 16, wherein outputting the enrichment data for the record comprises:
outputting the enrichment data in a portion of the interface, wherein the enrichment data corresponds to one or more fields being displayed in the interface.

19. The non-transitory computer-readable storage medium of claim 16, wherein:
the enrichment data is listed with the set of fields in a first portion of the interface, and
the set of fields is shown in a second portion of the interface for the record.

20. An apparatus comprising:
one or more computer processors; and
a computer-readable storage medium comprising instructions for controlling the one or more computer processors to be operable for:
selecting a set of fields in which data can be populated, wherein the set of fields are associated with a record in a database system;
retrieving a set of prompt templates that is associated with the set of fields, wherein a respective prompt template is retrieved for a respective field and comprises human-readable text and a variable in which context information can be inserted;
searching information that is associated with the record to determine context information, wherein context information includes values that are determined from values for the set of fields;
inserting the context information into variables in the prompt templates to generate a set of prompts for the set of fields, wherein prompts in the set of prompts include the human-readable text with the context information inserted in place of the variables;
inputting the set of prompts into a generative model to output a generated result, wherein the generative model is trained to output human-readable text based on the set of prompts as the generated result; and
outputting enrichment data for the record on an interface, wherein the enrichment data is based on the human-readable text of the generated result.
